(19) United States
(12) Patent Application Publication
(10) Pub. No.: US 2005/0269891 A1
(43) Pub. Date: Dec. 8, 2005

(54) Motor and manufacturing method for the same

(76) Inventors: Hiroaki Shinoki, Saitama (JP); Takaaki Nagi, Saitama (JP)

Correspondence Address: FISH & RICHARDSON P.C., P.O. BOX 1022, MINNEAPOLIS, MN, 55440-1022, US

(21) Appl. No.: 11/126,621

(22) Filed: May 10, 2005

(30) Foreign Application Priority Data
Jun. 4, 2004 (JP) P.2004-167061

(51) Int. Cl. H02K 3/12; H02K 1/16

(52) U.S. Cl. 310/180; 310/216

(57) ABSTRACT

A motor has a rotor, a housing and a stator including a substantially ring shaped yoke portion, a wire mounting portion provided on the yoke portion and having a core portion and pluralities of passage portions extending in an axial direction of the core portion and a wire wound around the wire mounting portion, wherein the wire is mounted to the passage portions which is at a position having a predetermined interval each other in a circumferential direction of the core portion and aligns along with an axial direction end face of the core portion, and the core portion has a width reducing portion of which width dimension in the circumferential direction is reduced from an interior of the core portion to an exterior of the core portion.

The present invention claims foreign priority to Japanese patent application no. P.2004-167061, filed on Jun. 4, 2004, the contents of which is incorporated herein by reference.

### BACKGROUND OF THE INVENTION

1. Field of the Invention

The present invention relates to a motor of a permanent magnet type or the like and a manufacturing method for the same.

2. Description of the Related Art

There is known a manufacturing method for a motor by mounting a plurality of U-like conductors to slots of a stator and forming phase wires by connecting front end portions of different ones of the U-like conductors (refer to, for example, Japanese Patent Unexamined Publication JP-A-2000-350423).

Meanwhile, in the motor manufactured by aforementioned method, the wire wound around a stator is constituted to include a wire main body portion mounted into a slot of the stator and a wire crossover portion for connecting different ones of the wire main body portions at outside of the slot. In order to downsize a motor, it is desired to shorten length of the wire crossover portion and reducing a space formed between a core (stator core) of the stator and the wire crossover portion to thereby increase a magnetic flux density contributing to generation of a torque of the motor.

However, in contrast to the wire main body portion extended along an axial direction of the stator core substantially in a cylindrical shape, the wire crossover portion is arranged to extend in a circumferential direction on an end face in the axial direction of the stator core. Accordingly, when, for example, the wire extended from the slot is bent to fold to be along the end face in the axial direction of the stator core, there are any possibilities of damaging the wire or an insulating coating layer of the wire at the portion of bending to fold the wire.

Further, even in the case in which the wire crossover portion is formed by gradually bending the wire extended from the slot without folding to bend the wire and thereafter, the wire crossover portion is shaped by pressing the wire crossover portion to the stator core. There are any possibilities of damaging the wire or the insulating coating layer of the wire in the shaping operation.

### SUMMARY OF THE INVENTION

The invention has been carried out in view of the above-described situation and it is an object thereof to provide a motor and a manufacturing method for a motor capable of increasing a magnetic flux density contributing to generation of a torque of the motor by reducing a space formed between a stator core and a wire crossover portion while preventing a wire and an insulating coating layer of a wire from being destructed.

In order to achieve the above-mentioned object, according to aspect 1 of the present invention, there is provided a motor comprising:
a rotor;
a stator generating a rotating magnetic field for rotating the rotor, the stator including:
   a substantially ring-shaped yoke portion (e.g. back yoke 31a);
   a wire mounting portion (e.g. teeth 31b and slot) provided at an inner peripheral or an outer peripheral of the yoke portion, the wire mounting portion having:
      a core portion; and
      pluralities of passage portions (e.g. slot) extending in an axial direction of the core portion; and
   a wire (e.g. stator wire 32) wound around the wire mounting portion; and
a housing fixing the stator,
wherein the wire is mounted to the passage portions which are positioned so as to have predetermined intervals each other in a circumferential direction of the core portion and aligns along with an axial direction end face of the core portion, and
the core portion has a width reducing portion (projected bent portion 52) of which width (L₁, Lₖ, Lₙ) in the circumferential direction is reduced from an interior of the core portion to an exterior of the core portion in the axial direction.

In other words, dimension of the width reducing portion in the circumferential direction is gradually reduced from center of the core portion to both ends of the core portion in the axial direction of the core portion as shown in FIG. 3.

According to aspect 2 of the present invention as set forth in the aspect 1, the passage portion is a through hole penetrating the core portion in the axial direction.

According to aspect 3 of the present invention as set forth in the aspect 1, the passage portion is a groove having its depth in radial direction of the core portion and extending in the axial direction.

According to the above-described motor, the wire wound around the wire mounting portion of the stator is constituted by including a wire main body portion mounted to the through hole or the groove portion of the core portion, and a wire crossover portion for connecting the wire main body portions different from each other at outside of the through hole or the groove portion, and the wire extended along the axial direction in the wire main body portion is smoothly bent along an outer face of the width reducing portion of the core portion at outside of the through hole or the groove portion and is smoothly connected to the wire of the wire crossover portion arranged along the end face in the axial direction of the core portion.

Thereby, a magnetic flux density contributing to generation of a torque of the motor can be increased by reducing a space formed between the core portion and the wire crossover portion and converging a magnetic flux by making the wire disposed along the outer face of the width reducing portion while preventing the wire and an insulating coating layer of the wire from being destructed by, for example, bending to fold the wire.

According to aspect 4 of the present invention as set forth in the aspect 3, wherein an opening end portion (an inner peripheral side end portion of the tooth 31b) of the groove in the radial direction has a claw portion (a wire holding claw 31c) extending in the circumferential direction.

According to the above-described motor, by bringing the wire wound around the wire mounting portion of the stator into contact with the claw portion, a state of wire, the wire can be maintained by restricting the core portion from moving in the radial direction.

According to aspect 5 of the present invention as set forth in the aspect 1, wherein pluralities of electromagnetic steel plates are laminated in the axial direction to form the stator in such a manner that width of the electromagnetic steel plate positioned at exterior in the axial direction is smaller than the width of the electromagnetic steel plate positioned at interior in the axial direction.

According to aspect 6 of the present invention as set forth in the aspect 1, wherein the core portion comprising the width reducing portion and a width constant portion of which width is constant along with the axial direction.

According to aspect 7 of the present invention as set forth in the aspect 1, wherein the width reducing portion of the core portion is formed of pluralities of plates.

According to aspect 8 of the present invention, there is provided a manufacturing method for a motor including:
a rotor;
a stator generating a rotating magnetic field for rotating the rotor, the stator including:
   a substantially ring-shaped yoke portion;
   a wire mounting portion provided at an inner peripheral or an outer peripheral of the yoke portion, the wire mounting portion having:
      a core portion; and
      pluralities of passage portions extending in an axial direction of the core portion; and
   a wire wound around the wire mounting portion; and
a housing fixing the stator,
wherein the wire is mounted to the passage portions which are positioned so as to have predetermined intervals each other in a circumferential direction of the core portion and aligns along with an axial direction end face of the core portion, and
the core portion has a width reducing portion of which width in the circumferential direction is gradually reduced from an interior of the core portion to an exterior of the core portion in the axial direction,
the manufacturing method comprising the step of:
laminating pluralities of electromagnetic steel plates in the axial direction to form the stator in such a manner that width of the electromagnetic steel plate positioned at exterior in the axial direction is smaller than the width of the electromagnetic steel plate positioned at interior in the axial direction.

According to the manufacturing method for the motor, in comparison with a case in which, for example, after forming a stator by laminating a plurality of electromagnetic steel plates having an equivalent width dimension of a width dimension variable portion, a width reducing portion is formed at an end portion in an axial direction of an core portion by polishing operation or the like, a step of forming the width reducing portion of a polishing step or the like can be omitted, complicated time and labor is prevented from being taken and a dimensional error with regard to a predetermined shape of the width reducing portion can be reduced.

According to the present invention, the magnetic flux density contributing to generation of the torque of the motor can be increased by reducing the space formed between the core portion and the wire crossover portion and converging the magnetic flux by making the wire disposed along the outer face of the reducing portion while preventing the wire and the insulating coating layer of the wire from damaging occurred by, for example, bending to fold the wire.

Further, according to the present invention, a state of wire the wire can be maintained by restricting the wire from moving in the radial direction by bringing the wire wound around the wire mounting portion of the stator into contact with the claw portion.

Further, according to the manufacturing method of the present invention, comparing with a step of forming the reducing portion by grinding or the like after forming the stator by pluralities of electromagnetic steel plate each of which has even width, it can omit the grinding steps or the like. Accordingly, it can save the trouble of grinding or the like and also reduce dimensional errors with regard to a desired shape of the reducing portion.

### BRIEF DESCRIPTION OF THE DRAWINGS

FIG. 1 is a disassembled perspective view of a motor according to an embodiment of the present invention;

FIG. 2 is a view showing a plurality of electromagnetic steel plates constituting the stator;

FIG. 3 illustrates a sectional view in a radial direction of a teeth portion constituted by laminating a plurality of teeth portions in a direction of a rotational axis line O; and a side view viewing along a direction of the rotational axis line O;

FIG. 4A is a side views in the direction of the rotational axis line O viewing a teeth portion arranged at an inner end of a projected bent portion along the direction of the rotational axis line O;

FIG. 4B is a side view in the direction of the rotational axis line O viewing a teeth portion arranged at a pertinent position between the inner end and an outer end of the projected bent portion along the direction of the rotational axis line O;

FIG. 4C is a side view in the direction of the rotational axis line O viewing a teeth portion arranged at the outer end of the projected bent portion along the direction of the rotational axis line O;

FIG. 5 is a view viewing an essential portion of a teeth wound with a stator wire from an outer side in the radial direction; and

FIG. 6 is a view showing an electromagnetic steel plate according to a modified example of the embodiment.

### DETAILED DESCRIPTION OF THE PREFERRED EMBODIMENTS

An embodiment of a motor of the present invention will be explained in reference to attached drawings as follows.

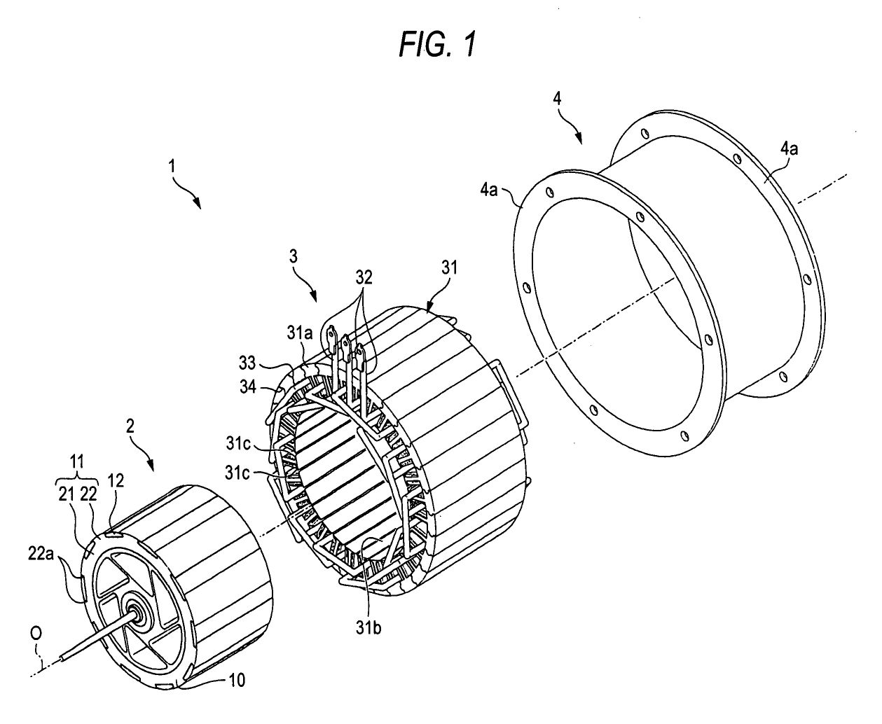

A motor 1 is a blushless DC motor constituting a driving source of a vehicle of, for example, a hybrid vehicle, a fuel cell vehicle or the like. The motor includes a rotor 2 substantially in a cylindrical shape made to be able to rotate around a rotational axis line O, a stator 3 substantially in a cylindrical shape including an inner peripheral portion opposed to an outer peripheral portion of the rotor 2, and a housing 4 for containing the stator 3 and the rotor 2 to cover an outer peripheral face of the stator 3 at inside thereof as shown in FIG. 1 through FIG. 3.

The rotor 2 is arranged at inside of the stator 3 to be rotatable around the rotational axis line O. The rotor 2 includes, for example, a rotor shaft 10 substantially in a cylindrical shape, a laminated core 11 mounted on an outer peripheral face of the rotor shaft 10, and a plurality of permanent magnets 12.

The laminated core 11 is formed by laminating a plurality of electromagnetic steel plates made of silicon steel plates or the like substantially in, for example, a ring-like shape in a direction of the rotational axis line O. The laminated core 11 includes a rotor core 21 substantially in a cylindrical shape and a plurality of projected pole portions 22 projected substantially in a rectangular shape in a sectional view thereof from an outer peripheral face of the rotor core 21 to an outer side in a radial direction at predetermined positions in a circumferential direction of the rotor core 21. The permanent magnet 12 substantially in a shape of a rectangular sheet is mounted between the projected pole portions 22, 22 continuous to each other in the circumferential direction to be interposed by the projected pole portions 22, 22 from both sides thereof.

Two magnet holding claw portions 22a, 22a projected to an outer side in the circumferential direction are formed on outer peripheral end portion of the projected pole portion 22. The magnet holding claw portions 22a, 22a are brought into contact with outer peripheral faces of the permanent magnet 12 mounted between the projected pole portions 22, 22 to restrict the permanent magnet 12 from moving to the outer side in the radial direction of the rotor core 21. That is, in the motor 1, a portion of the outer peripheral face of the permanent magnet 12 is exposed to the stator 3.

The permanent magnet 12 is, for example, a ferrite magnet, or a rare earth magnet of Nd—Fe—B species or Sm—Co species or the like and is magnetized in a radial direction. Further, the permanent magnets 12, 12 are arranged-such that magnetizing directions of the permanent magnets 12, 12 contiguous to each other in the circumferential direction are constituted by directions reverse to each other. That is, the permanent magnet 12 in which outer peripheral side is N pole is provided adjacent to the permanent magnet 12 in which inner side is S pole. Further, numbers of pieces of the plurality of permanent magnets 12 are constituted by an even number.

The stator 3 substantially in the cylindrical shape accommodating pluralities of stator pieces 31 arranged substantially in a ring-like shape at inside of the housing 4. The stator pieces 31 formed by laminating a plurality of electromagnetic steel plates made of silicon steel plates is substantially T-shaped in the direction of the rotational axis line O. Further, the stator pieces 31 includes a back yoke 31a and a tooth 31b extended from the back yoke 31a to an inner side in the circumferential direction, and the respective teeth 31b are wound with stator wires 32 of a plurality of phases (for example, 3 phases comprising U phase, V phase, W phase) for generating a rotating field for rotating the rotor 2 via insulating members (not illustrated).

Further, in two end portions in the circumferential direction of the back yoke 31a of each stator piece 31, one end portion thereof is formed with a projected portion 33 projected in the circumferential direction and other end portion thereof is formed with a recess portion 34 capable of fitting the projected portion 33. Thereby, the stator pieces 31, 31 contiguous in the circumferential direction are connected to fix to each other by being positioned in a predetermined relative arranging state by fitting the projected portion 33 of the back yoke 31a of one stator piece 31 to the recess portion 34 of the back yoke 31a of other stator piece 31.

Further, end portions on an inner peripheral side of the teeth 31b of each stator piece 31 are formed with two wire holding claws 31c, 31c projected to an outer side in the circumferential direction to restrict the stator wire 32 wound around each teeth 31b from moving to the inner side in the circumferential direction.

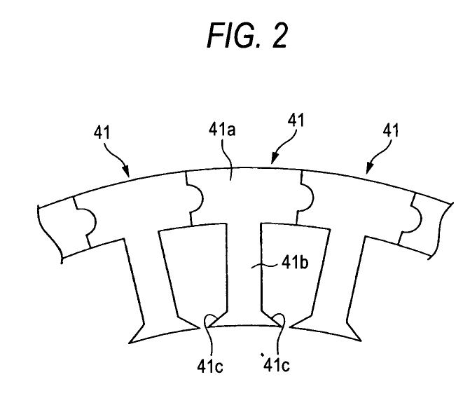

Thereby, an electromagnetic steel plate 41 substantially in a shape of a T-like sheet constituting the stator piece 31 includes a back yoke portion 41a, a tooth portion 41b extended from the back yoke portion 41a to an inner side in a circumferential direction, and two wire holding claw portions 41c, 41c projected to an outer side in the circumferential direction at end portions on an inner peripheral side of the tooth portion 41b as shown in FIG. 2.

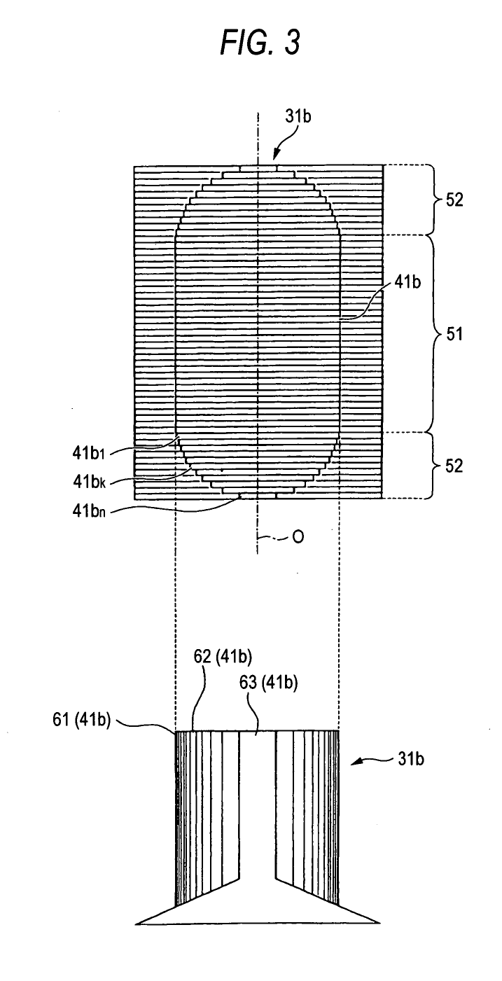

The tooth 31b of each stator piece 31 is constituted by including a tooth main body 51 comprising a center portion in the direction of the rotational axis line O and projected bent portions 52, 52 comprising both end portions in the direction of the rotational axis line O as shown in FIG. 3. Further, the tooth main body 51 is formed such that a length in a circumferential direction of the tooth main body 51 at a pertinent position along the direction of the rotational axis line O becomes a single length, and the projected bent portion 52 is formed such that a length in a circumferential direction is gradually shortened from an inner portion to an outer portion along the direction of the rotational axis line O. Alternatively, the tooth main body is formed such that an outer peripheral portion of the projected bent portion 52 includes an outer peripheral face in a shape of a smooth convex curve.

That is, with regard to the respective teeth portions 41b of the plurality of electromagnetic steel plates 41 laminated along the direction of the rotational axis line O to form each stator piece 31, lengths in the circumferential direction of the plurality of teeth portions 41b constituting the tooth main body 51 of the tooth 31b are set to lengths equivalent to each other. Further, lengths in the circumferential direction of the plurality of teeth portions 41b constituting the projected bent portion 52 of the tooth 31b are set to become shorter in accordance with being arranged to positions shifted to a further outer side along the direction of the rotational axis line O.

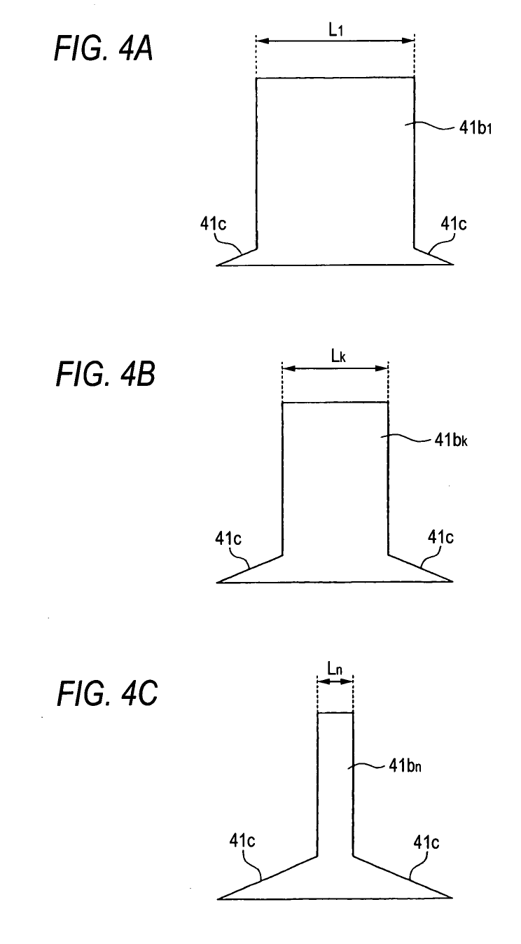

Thereby, as shown in FIG. 3 and FIGS. 4A through 4C, with regard to a plurality of teeth portions 41b₁, . . . , 41bₙ (n is an arbitrary natural number) constituting the projected bent portion 52 of the teeth 31b, there is established a relationship of L₁> . . . >Lₖ> . . . >Lₙ for a length L₁ in the circumferential direction of the tooth portion 41b₁ arranged at an inner end of the projected bent portion 52 along the direction of the rotational axis line O, a length Lₙ in the circumferential direction of the tooth portion 41bₙ arranged at an outer end of the projected bent portion 52 along the direction of the rotational axis line O, and a tooth portion 41bₖ (k=2, . . . , n−1) arranged at a pertinent position between the inner end and the outer end of the projected bent portion 52 along the direction of the rotational axis line O.

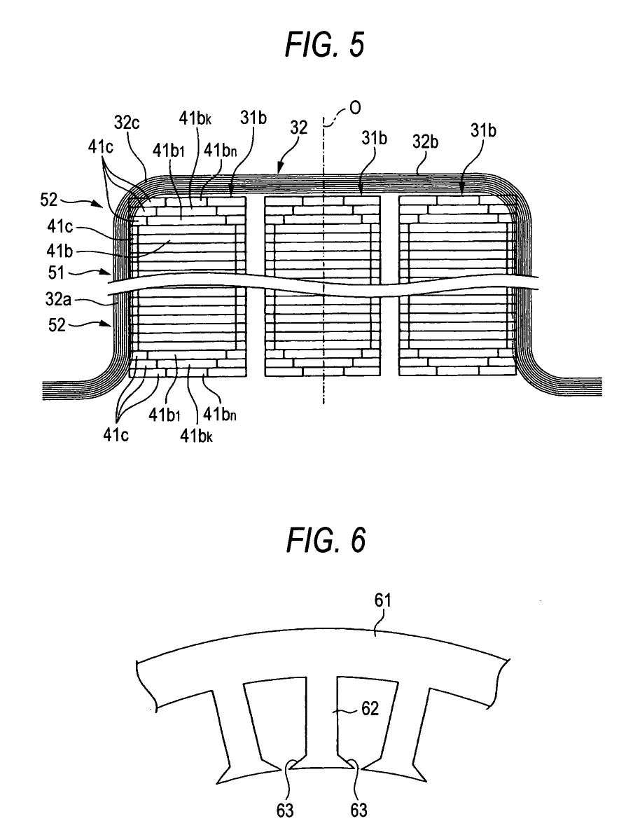

Thereby, in the stator wire 32 wound around each teeth 31b, as shown in FIG. 5, a wire main body portion 32a arranged at a slot between the contiguous teeth 31b, 31b in the circumferential direction and extended in the direction of the rotational axis line O along the outer peripheral portion of the tooth main body 51 of the teeth 31b, and a circumferential direction crossover portion 32b extended in the circumferential direction along an end portion in the direction of the rotational axis line O of each teeth 31b to ride over a plurality (for example, three) of the teeth 31b are smoothly connected via a bent crossover portion 32c bent smoothly along an outer face of the projected bent portion 52 of the teeth 31b.

Further, the housing 4 covering the outer peripheral face of the stator 3 is formed by a nonmagnetic member made of, for example, an aluminum alloy or the like and both end portions thereof in the direction of the rotational axis line O are formed with flange portions 4a, 4a for connecting the housing 4 to fix to other apparatus (for example, an internal combustion engine of a vehicle or the like). Further, the stator 3 inserted into the housing 4 is fixed in a state of tight fitting.

That is, an inner diameter of the housing 4 is set to provide a predetermined tight fitting margin relative to an outer diameter of the stator 3. When fixing the stator 3 to the housing 4, first, the housing 4 is heated to thermally expand the inner diameter of the housing 4 until the stator 3 can be inserted and thereafter, the stator 3 is inserted into the housing 4. Next, when the housing 4 is cooled, the inner diameter of the housing 4 is thermally contracted to tighten the stator 3 to finish to fix the stator 3.

Further, as a manufacturing method for the motor 1, particularly, a method of forming the projected bent portion 52 of the tooth 31b, for example, in forming each stator piece 31 by laminating the plurality of electromagnetic steel plates 41, along the direction of the rotational axis line O, the electromagnetic steel plate 41 having a length Lⱼ (1≦j≦n−1) in the circumferential direction of the tooth portion 41bⱼ is arranged with the electromagnetic steel plate 41 having a length Lⱼ₊₁ (>Lⱼ) in the circumferential direction of the teeth portion 41bⱼ₊₁ such that the teeth portion 41b j+1 is contiguous to an outer side in the direction of the rotational axis line O of the teeth portion 41bⱼ.

As described above, according to the motor 1 of the embodiment, a space formed among the tooth 31b and the circumferential direction crossover portion 32b and the bent crossover portion 32c can be reduced and a magnetic flux can be converged. Further, the magnetic flux density contributing to generation of the torque of the motor 1 can be increased by disposing the stator wire 32 along the outer face of the projected bent portion 52 while preventing the stator wire 32 and the insulating coating layer of the stator wire 32 from being destructed by bending to fold the stator wire 32. Furthermore, by bringing the stator wire 32 wound around the tooth 31b into contact with the wire holding claw 31c, the stator wire 32 can be restricted from moving in the radial direction and the state of wire the stator wire 32 can be maintained.

Further, according to the manufacturing method for the motor 1 of the embodiment, in comparison with a case of forming the projected bent portion 42 at the end portion in the axial direction of the tooth 31b by grinding or the like after forming each stator piece 31 by laminating the plurality of electromagnetic steel plates 41 having even lengths each other in the circumferential direction of the teeth portion 41bₙ, troublesome time and labor can be saved and a dimensional error of the projected bent portion 42 relative to a desired shape can be reduced.

Further, although according to the above-described embodiment, the stator 3 is constituted by the plurality of stator pieces 31 arranged substantially in the ring-like shape, the embodiment is not limited thereto. For example, a yoke and a plurality of tees may integrally be formed. In this case, as shown in FIG. 6, each of a plurality of electromagnetic steel plates laminated to form the stator 3 is integrally formed with a yoke portion 61 in a shape of a ring-like sheet, a plurality of teeth 62 projected from positions at predetermined intervals in a circumferential direction of the yoke portion 61 to inner sides in the radial direction, and two wire holding claws 63, 63 projected to an outer side in the circumferential direction at an end portion on an inner peripheral side of each teeth 62.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

1. A motor comprising:
a rotor;
a stator generating a rotating magnetic field for rotating the rotor, the stator including:
a substantially ring-shaped yoke portion;
a wire mounting portion provided at an inner peripheral or an outer peripheral of the yoke portion, the wire mounting portion having:
a core portion; and
pluralities of passage portions extending in an axial direction of the core portion; and
a wire wound around the wire mounting portion; and
a housing fixing the stator,
wherein the wire is mounted to the passage portions which are positioned so as to have predetermined intervals each other in a circumferential direction of the core portion and aligns along with an axial direction end face of the core portion, and
the core portion has a width reducing portion of which width in the circumferential direction is gradually reduced from an interior of the core portion to an exterior of the core portion in the axial direction.

2. The motor according to claim 1, wherein the passage portion is a through hole penetrating the core portion in the axial direction.

3. The motor according to claim 1, wherein the passage portion is a groove having its depth in radial direction of the core portion and extending in the axial direction.

4. The motor according to claim 3, wherein an opening end portion of the groove in the radial direction has a claw portion extending in the circumferential direction.

5. The motor according to claim 1, wherein pluralities of electromagnetic steel plates are laminated in the axial direction to form the stator in such a manner that width of the electromagnetic steel plate positioned at exterior in the axial direction is smaller than the width of the electromagnetic steel plate positioned at interior in the axial direction.

6. The motor according to claim 1, wherein the core portion comprising the width reducing portion and a width constant portion of which width is constant along with the axial direction.

7. The motor according to claim 1, wherein the width reducing portion of the core portion is formed of pluralities of plates.

8. A manufacturing method for a motor including:
a rotor;
a stator generating a rotating magnetic field for rotating the rotor, the stator including:
a substantially ring-shaped yoke portion;
a wire mounting portion provided at an inner peripheral or an outer peripheral of the yoke portion, the wire mounting portion having:
a core portion; and
pluralities of passage portions extending in an axial direction of the core portion; and
a wire wound around the wire mounting portion; and
a housing fixing the stator,
wherein the wire is mounted to the passage portions which are positioned so as to have predetermined intervals each other in a circumferential direction of the core portion and aligns along with an axial direction end face of the core portion, and
the core portion has a width reducing portion of which width in the circumferential direction is gradually reduced from an interior of the core portion to an exterior of the core portion in the axial direction,
the manufacturing method comprising the step of:
laminating pluralities of electromagnetic steel plates in the axial direction to form the stator in such a manner that width of the electromagnetic steel plate positioned at exterior in the axial direction is smaller than the width of the electromagnetic steel plate positioned at interior in the axial direction.
